(19) United States
(12) Patent Application Publication
(10) Pub. No.: US 2017/0274543 A1
(43) Pub. Date: Sep. 28, 2017

(54) RAZOR

(71) Applicant: Robert Quarantello, Houston, TX (US)

(72) Inventor: Robert Quarantello, Houston, TX (US)

(21) Appl. No.: 15/081,926

(22) Filed: Mar. 27, 2016

(51) Int. Cl. B26B 21/52; B26B 21/22; B26B 21/06; B26B 21/16

(52) U.S. Cl. CPC B26B 21/522; B26B 21/521; B26B 21/165; B26B 21/225; B26B 21/06

(57) ABSTRACT

A razor or personal shaving device having a handle and two legs. Each leg has at its base at least one blade or blade cartridge containing at least one blade. The blades in the legs are positioned parallel to each other with the sharp edges pointing inward toward one another so that when the blades in one leg are cutting hair, the blades in the other leg are moving along the skin without cutting hair. The device allows shaving in a back and forth motion.

### RELATED APPLICATION

This application claims priority to U.S. Provisional Application Serial No. 62/302,138, filed Mar. 1, 2016.

### FIELD OF THE INVENTION

The present invention relates generally to a personal grooming device, and more particularly to a personal shaving device or razor for shaving whiskers or other facial or body hair.

### BACKGROUND OF THE INVENTION

Shaving razors are known in a variety of forms and today are commonly comprised of a disposable razor cartridge coupled to a handle which may or may not itself also be disposable. The razor cartridge may include one or more razor blades disposed on a cutting surface of the cartridge. Once the razor blades are dull, the user may disconnect the razor cartridge from the handle and reconnect a new razor cartridge, or toss the entire razor, including handle and cartridge.

Razor handles are typically optimized, if at all, for shaving the face. Even razor handles for razors for shaving legs are typically just elongated versions of the handles for razors for shaving the face. Such razors are nevertheless not ideal for shaving legs, or other parts of the body, such as the arms and chest. A need exists for razors of a design that facilitates ease of shaving parts of the body other than the face, as well as the face.

### BRIEF DESCRIPTION OF THE FIGURES

FIG. 1 is a perspective view of one embodiment of the razor of the invention.

FIG. 2 is side view of the razor shown in FIG. 1.

FIG. 3 is a side view of the razor shown in FIGS. 1 and 2, turned 90 degrees from the position shown in FIG. 2.

FIG. 4 is a bottom or upside down view of the razor shown in FIG. 1.

FIG. 5 is an above or top side view of the razor shown in FIG. 1.

FIG. 6 is another side view of the razor shown in FIG. 2, but taken more from the underneath perspective to show the blades in the cartridges on the legs.

FIG. 7 is a side view of another embodiment of a razor of the invention, having an attachment of the blade cartridges to the legs that allows some pivoting upward of the cartridges while maintaining at least a portion of the cartridge to function as a base for the legs.

FIG. 8 is a perspective view of still another embodiment of a razor of the invention. This embodiment is much like the embodiment shown in FIG. 1, except that this embodiment is larger, for a larger user's hand, and has larger blade cartridges attached to the legs.

FIG. 9 is a side view of the razor shown in FIG. 8, taken from a top perspective.

FIG. 10 is a bottom or upside view of the razor shown in FIG. 8.

FIG. 11 is an enlarged bottom or upside view of another embodiment of the razor of the invention having single blade cartridges and showing by such enlargement the direction the cutting edge of the blades is positioned in the razor of the invention.

### SUMMARY

The present invention provides a disposable shaving device or razor, or a shaving device or razor having disposable blades (or disposable blade cartridges), that has a novel shape which allows for shaving in a novel way if desired, with a back and forth or upward and downward motion, instead of with all strokes in the same direction or with all forward strokes or all upward or all downward strokes.

The razor of the invention comprises a handle connected to a pair of legs, wherein each of the legs has at its distal end from the handle, at least one razor blade, or set of razor blades, or at least one blade cartridge containing at least one blade, and the legs are spaced apart one from the other. In one embodiment, the cartridge comprises the leg base. The blades or the blade cartridges in the legs are positioned generally parallel to each other—one leg to the other—such that the cutting edges of the blades (or the blades in the blade cartridges) rest at least in part on an approximately 180 degree plane and face one another, that is, point inwardly or toward one another, so that in use, the blade(s) (or blade(s) in one cartridge) on one leg is cutting hair while the other blade(s) (or blade(s) in the other cartridge) on the other leg is not cutting and instead is moving hair, moving cut hair, or moving along skin with freshly cut hair or no hair. If and when each leg has a set of blades or a blade cartridge with more than one blade within it, each of such blades on a leg has a cutting edge pointing in the same direction, and the cutting edges are spaced adjacent one another so that each blade cuts hair when the leg is moved in the direction for the blades to cut.

In one embodiment, the pair of legs are positioned such that the blades or cartridges at the distal end of the legs are positioned at least about one blade or cartridge apart, leaving enough space for at least one like or similarly sized blade or cartridge to be fitted in parallel between them (although no such third blade or cartridge is actually used). In one embodiment, the legs are positioned such that the blades or cartridges at the distal end of the legs are positioned approximately two to three blades or cartridges apart—that is, the space or distance between the blade(s) or cartridge on one leg and the blade(s) or cartridge on the other leg is about the width of two to three similarly sized blades or cartridges if they were also positioned parallel to and in between the pair (although no such additional blades or cartridges are actually added). In one embodiment, the legs, and particularly the blades or cartridges of the legs, are spaced apart so that the outer edges of the blades or cartridges do not extend substantially, if at all, beyond the width of the handle at the handle's broadest point. In one embodiment, the legs, and particularly the blades or cartridges of the legs, are spaced apart so that their outer edges of the blades or cartridges extend just beyond the outer edges of the handle at the handle's broadest point. In one embodiment, the legs, and particularly the blades or cartridges of the legs, are spaced apart so that the inner edges of the blades or cartridges are approximately in line with the outer edges of the handle at the handle's broadest point.

In one embodiment, the legs are fixedly connected to the handle. In one embodiment the legs are adjustable so that the spacing between the legs, and consequently the spacing between the blades or cartridges on the distal ends of the legs, can be varied as desired, provided that the adjustment may be made at least temporarily fixed so the legs do not move during use, and that the blades or cartridges on the legs remain apart and parallel and have at least a portion that comprises a base for the legs. In one embodiment, the blades or cartridges are removable and replaceable, and in another embodiment, the blades or cartridges are not removable or replaceable. In one embodiment, the legs and the handle are one piece, comprised of the same material such as extruded plastic or acrylic polymer, wood, or metal such as, for example, stainless steel, aluminum, copper, copper plate, silver plate, or silver.

In one embodiment, the handle is ergonomic and may fit in the palm of a user's hand. In one embodiment, the handle comprises a knob, which optionally has side ridges, atop the two legs. The knob is round or circular with a disc top in one embodiment, but can have other shapes in other embodiments, including any polygonal shape, lever shape, or even an amorphous shape, so long as the shape is ergonomic in feel and size, affording the user ease of gripping and shaving with the razor in any direction desired by the user.

### DETAILED DESCRIPTION

The present disclosure is not limited in its application to the details of construction and the arrangement of components set forth in the following description or illustrated in the drawings. The invention may be capable of other embodiments and of being practiced or being carried out in various ways. Also, the phraseology and terminology used herein is for the purpose of description and should not be regarded as limiting as understood by one of skill in the art.

The present invention provides a lightweight, economical, shaving device or razor that has an easy to hold handle that enables a user to easily control the cutting blades while shaving in any direction. The invention has the further advantage of enabling the user to quickly and easily change the direction of the cutting with the razor while shaving. The razor may be entirely disposable, or the razor may be reusable, with disposable blades or blade cartridges.

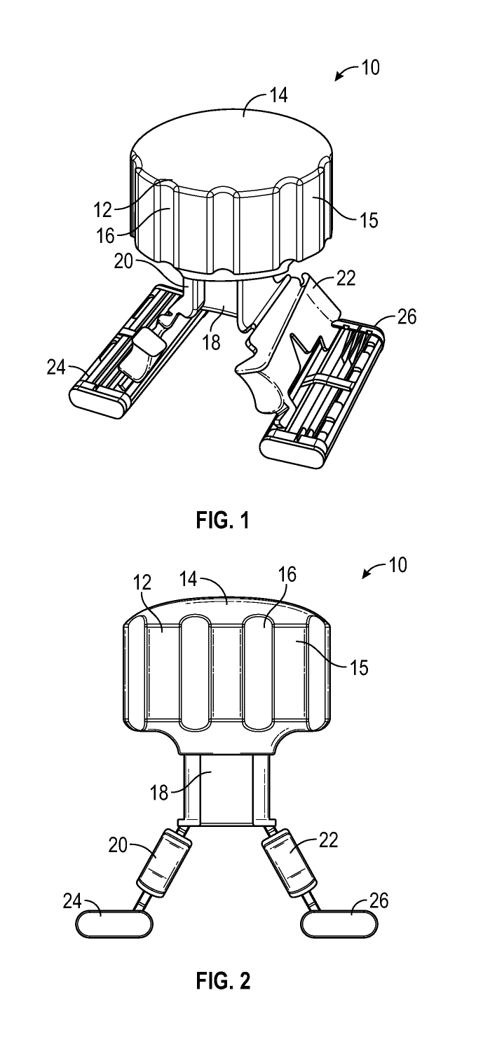

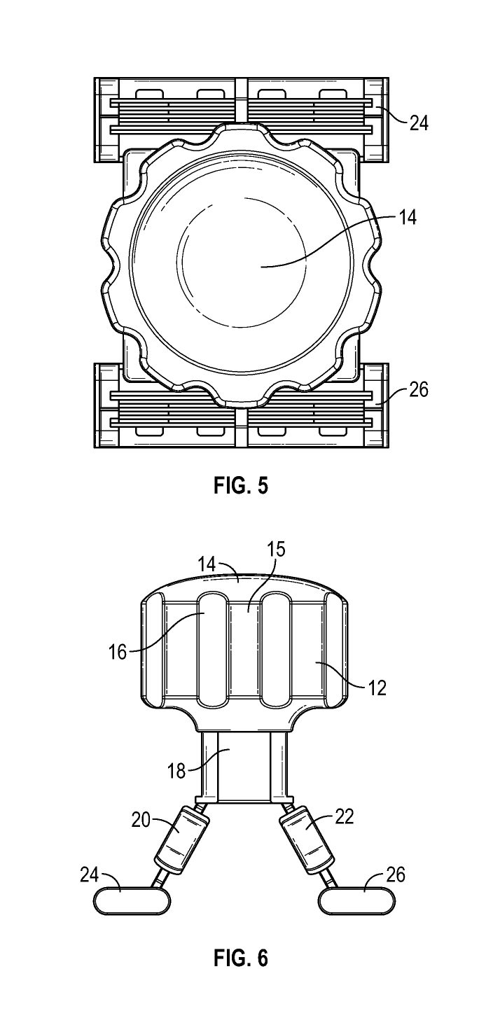

FIG. 1-6 illustrate one embodiment of the invention. Razor 10 has a knob 12 for holding the razor. Knob 12 has a disc shaped top surface 14 and a relatively round or circular body 15 with side ridges 16 to enable the knob to be easier for the user to grip, especially with a wet hand. Knob 12 is believed to be ergonomic in shape and sized to easily fit in the palm of a user's hand for holding with the palm and fingers or just with the fingers as the user finds most comfortable and effective for control of the razor 10 during shaving with razor 10. It is contemplated that knob 12 will be sized larger for razors intended for use by a man than for razors intended for use by a woman, considering that the average man's hand is larger than the average woman's hand, and such size difference in knob 12 is expected to be proportional to that difference in hand size between the sexes.

In other embodiments, knob 12 could have a slightly different appearance. For example, knob 12 could have smooth sides, knob 12 could have a flat top, knob 12 could be oval, oblong, square, rectangular, pentagonal, hexagonal, octagonal, or have another polygonal shape, or knob 12 could have a lever type shape, or even an amorphous shape, instead of round as shown, provided the shape is conducive to ease of gripping the razor and affords the user ready control during use. That is, other knob shapes than shown are foreseeable so long as the proportions are similar to those taught and shown.

Knob 12 is attached to legs 20 and 22 which are themselves attached respectively to blade cartridges 24 and 26. The attachments are fixed in one embodiment and in one embodiment the knob and legs are comprised of a single piece of material such as plastic, acrylic, wood, or metal. In the Figures, legs 20 and 22 are shown attached to knob 12 via a connector piece 18, but it is contemplated that in another embodiment, legs 20 and 22 could attach directly to knob 12 without the connector piece 18. The length of the legs 20 and 22 should be such as to enable a user to see the location of the blades or the blade cartridges sufficiently for safe use while still affording sufficient compactness of the razor to allow for comfort and easy control during use.

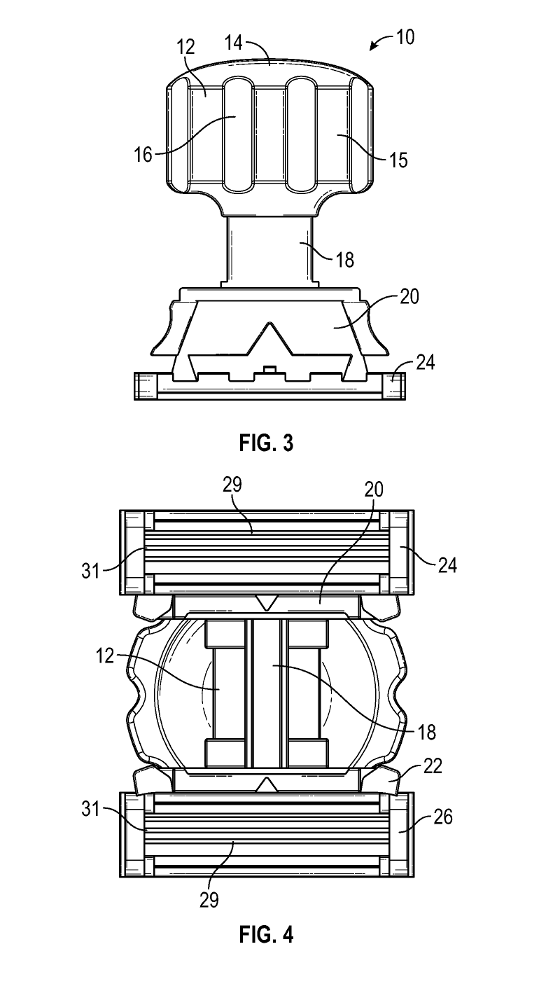

In FIG. 3, razor 10 is turned at a right angle from its position in FIG. 2, showing the side of cartridge 24. The side of cartridge 26 would look the same when razor 10 is turned another 180 degrees.

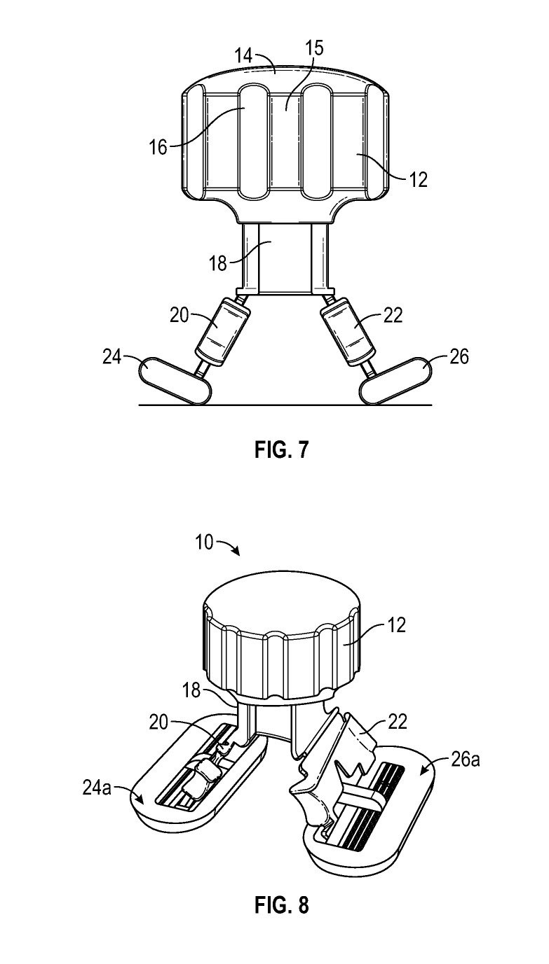

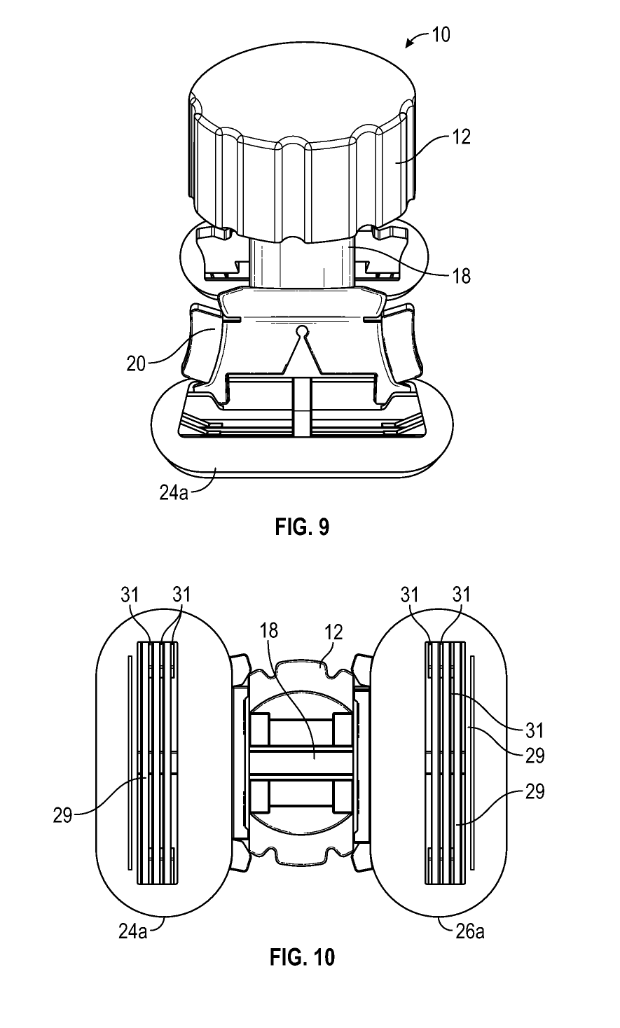

The attachment of the blade cartridges 24 and 26 to respective legs 20 and 22 is accomplished by any known method for attaching blade cartridges to a handle. For example, one or more prongs or hooks may be in place on the distal end of the leg to grip at least one edge of the blade or cartridge. For another example, the distal end of the leg may have a channel for slidably receiving at least one edge of the blade or cartridge. Attachers for attaching or connecting the blade cartridges 24 and 26 to respective legs 22 and 24 should not interfere with the operation of the blades for cutting hair. In one embodiment, the attachers hold the blade or cartridge in a fixed position. In another embodiment, the attachers allow some flexibility in the grip of the cartridges 24 and 26 so that the cartridges may move slightly, as illustrated in FIG. 7, to more easily slide across skin in cutting hair. Such flexible attachment is accomplished by any known method for attaching blade cartridges to a handle with flexibility in the attachment, so long as the flexibility does not amount to a pivot that allows the blade or blade cartridge to change direction or to move so much as to miss cutting hair. In one embodiment, the attachers allow replacement of the blade or blade cartridge, and in another embodiment, the attachers do not allow replacement of the blade or blade cartridge.

As discussed above, in one embodiment, the legs, connecting the handle to the razor blades, may accept razor blades in the distal or blade receiving ends of the legs directly, without need for cartridges to contain the blades. In that embodiment, it is contemplated that the entire razor would be disposable or that the receiving ends of the legs would allow removal and replacement of the blades. Such attachments of the blades to the legs are accomplished by any known method for attaching blades to a handle without the blades being in a cartridge.

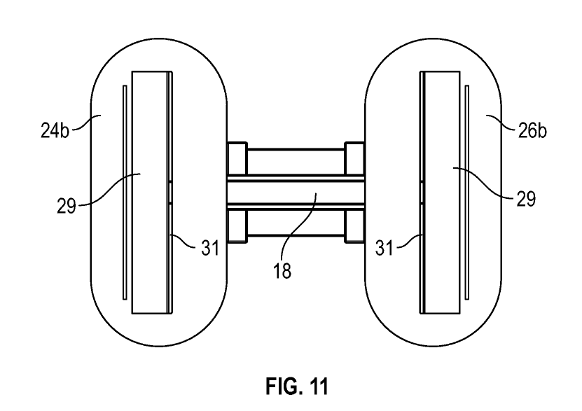

As shown in FIGS. 1, 2, 4, 5, 6, 8, 10, and 11, and especially in FIGS. 4, 10, and 11, that is, cartridges 24 and 26 (FIG. 4), cartridges 24a and 26a (FIG. 10), and cartridges 24b and 26b (FIG. 11), are positioned so that the blades 29 in each face one another. That is, cartridge 24 (or cartridge 24a or 24b) is positioned so that the sharp or cutting edge 31 of the blades is positioned in the direction toward the inside of the legs or toward the other cartridge 26 (or cartridge 26a or 26b), and cartridge 26 (or cartridge 26a or 26b) is positioned in a reciprocal manner, so that the sharp or cutting edge of the blades 31 is positioned in the direction toward the inside of the legs or toward the other cartridge 24 (or cartridge 24a or 24b).

The cartridges 24 and 26 and 24a and 26a are shown, for example, each with three adjacent blades, one spaced slightly above the other to enable each to be used during shaving as is common for multiple blades in a blade cartridge for razors. However, cartridges with other numbers of blades could be used instead, such as for nonlimiting example, single blade cartridges as shown in FIG. 11, five bladed cartridges (not shown) and even ten bladed cartridges (not shown). It is contemplated that the cartridges comprising the pair used on razor 10 will be identical, or essentially identical, but the invention would still be operable if the cartridges varied one from another in the number of blades in the two cartridges.

In one embodiment, the cartridges 24 and 26 (and cartridges 24a and 26a) are respectively attached to legs 20 and 22 at an angle that will afford the cartridges to be parallel with one another so that at least a portion of the blade or cartridge is on a horizontal plane so that the razor 10 can essentially stand on cartridges 24 and 26 (and cartridges 24a and 26a) as shown in FIG. 1 (and FIG. 8), when positioned on a flat or horizontal surface, such as a counter top or table. If cartridges are not used for holding the blades, the blades are positioned in each leg or at the base of one leg with respect to each other in the same manner as described above when the blades are in cartridges, that is, the sharp edge of the blade in one leg or at the base of one leg would be facing the sharp edge of the blade in the other leg or at the base of the other leg. That is, the blades on the legs are facing inward. When the razor is in use in cutting hair, this positioning of the sharp edges of the blades, each facing inward, causes the blade(s) alone or in a cartridge on one leg to be cutting hair while the blade(s) alone or in a cartridge on the other leg is moving hair, moving cut hair, or moving along skin with freshly cut hair or no hair, for a quick, smooth shave. Thus, a person shaving using a simple back-and-forth motion with the razor of the invention, is shaving or cutting hair or whiskers with the blade(s) on one leg of the razor while exfoliating skin and clearing the blade(s) on the opposing leg of the razor. The need to rinse the blades during shaving is reduced or eliminated altogether, and the overall time required to shave is also significantly reduced, or even reduced by half. The inward-facing blades of the razor of the invention efficiently shave both with and against the grain of the hair, making the razor of the invention optimal for shaving arms, legs, and chest, and resulting in a smoother shave than with traditional or commonly known razors.

Razor 10 may be comprised of plastic, acrylic, wood, or metal, or a combination thereof. In one embodiment, for nonlimiting example, razor 10 is comprised of a single piece of extruded plastic or acrylic apart from the blade cartridge containing one or more blades. In another embodiment, for nonlimiting example, knob 12 and legs 20 and 22 are comprised of one piece of shaped wood. In another embodiment, for nonlimiting example, razor 10 is comprised of metal where knob 12 and legs 20 and 22 are all formed of one metal or are made of separate metal pieces welded or otherwise connected together.

While preferred embodiments of the present disclosure have been described, it should be understood that various changes, adaptations and modifications can be made therein without departing from the spirit of the invention(s) and the scope of the appended claims. The scope of the present disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A shaving device or razor for cutting hair or whiskers comprising: a handle comprising or attached to a first and second leg, wherein the first and second legs are spaced apart and each have at their distal end from the handle at least one razor blade with a cutting edge, and each such blade in the first leg is positioned so as to have a cutting edge pointing inward toward a blade in the second leg and each such blade in the second leg is positioned so as to have a cutting edge pointing toward a blade in the first leg, so that in use, only one of the two legs of the device is cutting hair or whiskers at a time, and a back and forth motion can be used for cutting hair or whiskers.

2. The device of claim 1 wherein the blade or blades in the distal end of the first leg are positioned to be parallel to the blade or blades in the distal end of the second leg.

3. The device of claim 1 wherein each blade in the first leg corresponds to a blade in the second leg.

4. The device of claim 1 wherein the blades in the distal ends of the legs are housed in blade cartridges.

5. The device of claim 4 wherein the base of the legs is comprised of the blade cartridges such that the legs sit on the cartridges and enable the device to stand upright on a flat, horizontal surface.

6. The device of claim 5 wherein the outer edges of the cartridges are approximately in line with the outer edges of the handle.

7. The device of claim 5 wherein the inner edges of the cartridges are approximately in line with the outer edges of the handle.

8. The device of claim 5 wherein the outer edges of the cartridges extend beyond the outer edges of the handle.

9. The device of claim 4 wherein the blade cartridges are attached to the legs by connectors that allow the cartridges to move or pivot sufficiently for the device to move across skin smoothly.

10. The device of claim 4 wherein each blade cartridge is fixedly attached to the first leg or the second leg.

11. The device of claim 4 wherein the cartridges are removable and disposable.

12. The device of claim 1 wherein the blades are removable and disposable.

13. The device of claim 1 wherein the entire device is disposable.

14. The device of claim 1 wherein the handle comprises a connector for attaching the legs to the handle.

15. The device of claim 14 wherein the connector attaches the legs in a manner to cause the legs to be spaced apart at an angle that causes the distal ends of the legs comprising the blades to be positioned so that the blades rest at least in part on an approximately 180 degree plane and the blade or blades on the first leg face the blade or blades on the second leg.

16. The device of claim 1 wherein the legs are fixedly connected to the handle.

17. The device of claim 1 wherein the legs are adjustable so that the spacing between the legs can be varied and made at least temporarily fixed for use.

18. The device of claim 1 wherein the handle has an ergonomic shape that fits in the palm of a user's hand.

19. The device of claim 1 wherein the handle and legs are comprised of a single material selected from the group consisting of extruded plastic, molded plastic, acrylic polymer, wood, stainless steel, aluminum, copper, copper plate, silver, silver plate, or other metal.

20. The device of claim 1 wherein the handle comprises a knob.

21. The device of claim 20 wherein the knob is rounded, oval, oblong, polygonal, lever, or amorphous in shape.

22. The device of claim 21 wherein the knob has exterior ridges about its surface positioned to facilitate easier gripping when wet.
